(19) United States
(12) Patent Application Publication
(10) Pub. No.: US 2026/0361704 A1
(43) Pub. Date: Nov. 12, 2026

(54) SECURE INFORMATION SYSTEMS AND ENCRYPTION INFRASTRUCTURE FOR SUPPORTING NETWORK PUBLICATIONS OF SENSITIVE DATA

(71) Applicant: Optum Services (Ireland) Limited, Dublin (IE)

(72) Inventor: Alan Brady, Kildare (IE)

(21) Appl. No.: 19/203,378

(22) Filed: May 9, 2025

(51) Int. Cl. H04L 9/40; H04L 9/08

(52) U.S. Cl. CPC H04L 63/0442; H04L 9/0816

(57) ABSTRACT

Various embodiments of the present disclosure provide an incremental information sharing process that improves the functionality of a computer in various aspects. The techniques comprise receiving, from a requesting computing entity, an encrypted data publication request and decrypting the encrypted data publication request to receive a data publication request that identifies (a) a target entity, (b) a set of entity attributes, (c) a condition, and (d) an assigned correction for the condition. The techniques comprise generating a data publication from the data publication request, encrypting the data publication request to regenerate the encrypted data publication request, and storing the data publication within a public decentralized environment and the encrypted data publication request within a private environment with an association to the data publication. In response to an information request, the techniques may provide an information response based on the encrypted data publication request.

### BACKGROUND

In many domains, centralized systems have traditionally been used to manage and process confidential information exchanges between multiple parties. However, these centralized approaches often face limitations in terms of scalability and real time processing as they present bottlenecks that impede the speed and efficiency of communication across parties.

For example, historical techniques for managing sensitive data exchanges have relied on centralized databases and intermediaries to facilitate communications. These methods typically involve storing all participant information in a single location, which may create vulnerabilities to data breaches and unauthorized access. Additionally, centralized systems may struggle to efficiently process high volumes of concurrent requests from multiple parties, leading to bottlenecks and reduced performance. These limitations require computer architectural decisions that must choose between the (i) speed, traceability, and communication efficiency offered by distributed systems and (ii) increased security measures offered by centralized approaches.

Traditional architectures and communication approaches for balancing speed with security fail to (i) ensure data privacy and security when handling sensitive information from multiple parties, (ii) maintain system performance and scalability when processing large volumes of concurrent requests, (iii) provide transparent yet secure access to relevant information for authorized participants, or (iv) enable efficient updates and modifications to shared data while maintaining consistency across the network.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is a system diagram of an example computing ecosystem in accordance with some embodiments of the present disclosure.

FIG. 5 is a dataflow diagram of a secure partial data publication technique in accordance with some embodiments of the present disclosure.

FIG. 6 is a dataflow diagram of a secure publication processing technique in accordance with some embodiments of the present disclosure.

FIG. 7 is a flowchart diagram of an encrypted exchange process in accordance with some embodiments of the present disclosure.

### DETAILED DESCRIPTION

Various embodiments of the present disclosure provide improved data security within decentralized computing environments. To achieve this, some embodiments of the present disclosure implement a multi-stage encryption and decryption process for handling sensitive data requests and responses between computing entities. The multi-stage encryption and decryption process may integrate security measures within a public decentralized environment to marry the speed, efficiency, and traceability features of a decentralized system with the enhanced security measures offered by centralized counterparts. For example, using the techniques of the present disclosure, an intermediary computing entity may control data flow between affiliated entities using a combination of a public decentralized environment, for nonprotected data, and adjacent, secure communication channels, for protected data. Specifically, the intermediary computing entity may post data publications to a public decentralized environment that comprise a portion of nonprotected data from an encrypted data publication request. The data publications may be linked back to their encrypted data publication requests to allow for the provisioning of supplementary data for the data publications through secure channels between the intermediary computing entity and participating computing entities of the public decentralized environment. In this manner, the intermediary computing entity may provide data in an unconstrained manner through the public decentralized environment, while supplementing the data through adjacent, secure channels. By doing so, the intermediary computing entity provides enhanced security measures for protected data, while distributing unprotected data in a scalable manner. Ultimately, this reduces bottlenecks to the information system, while maintaining security measures required for protected information within the information system – effectively balancing speed and scalability with enhanced data security. This, in turn, overcomes technical challenges for information systems by maintaining data privacy while enabling selective information sharing in distributed systems.

More particularly, some embodiments of the present disclosure leverage an intermediary computing entity to manage encrypted data publication requests within a public decentralized environment accessible to multiple participating computing entities. During an initial publication procedure, the intermediary computing entity may encrypt full data publication requests and store them within a private environment. At substantially the same time, the intermediary computing entity may extract a limited portion of data from the data publication request and expose it within a public decentralized environment. In this way, the intermediary computing entity may expose a limited portion of a data publication request without exposing protected attributes underlying the publication. By doing so, the intermediary computing entity may facilitate interactions within a distributed computing environment, while addresses security vulnerabilities present in traditional centralized data storage and sharing architectures.

To enable controlled information exchange between entities within the environment, the intermediary computing entity may implement an incremental encryption-based information sharing technique in which protected information may be provided through secure channels adjacent to the distributed environment in an ad hoc manner. For example, the intermediary computing entity may receive information requests from participating entities within the distributed environment that may identify specific attributes associated with a data publication. The intermediary computing entity may selectively decrypt and provide limited portions of protected attributes in response to the specific information requests. By doing so, the intermediary computing entity leverages a second channel, adjacent to a distributed environment to incrementally provide protected attributes based on specific requests (or assertions) made by the participating entities within the distributed environment. In this way, the intermediary computing entity may maintain granular control over data access while still allowing necessary information exchange. This overcomes limitations of all-or-nothing data sharing approaches that risk oversharing of sensitive details.

Through these technical innovations, the disclosed techniques provide a secure and flexible framework for selective information sharing in decentralized computing environments while maintaining strong data privacy protections. This enables new possibilities for privacy-preserving data exchange and collaboration across distributed networks of computing entities, as described throughout the present disclosure. Examples of technologically advantageous embodiments of the present disclosure comprise a distributed network architecture operating in an unconventional fashion to reduce network congestion, while enhancing security measures, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

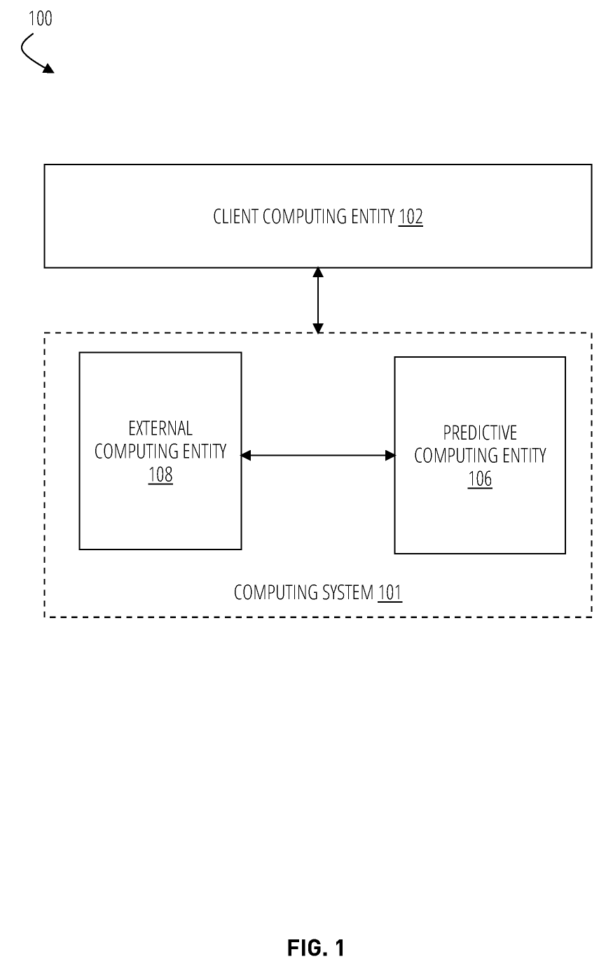

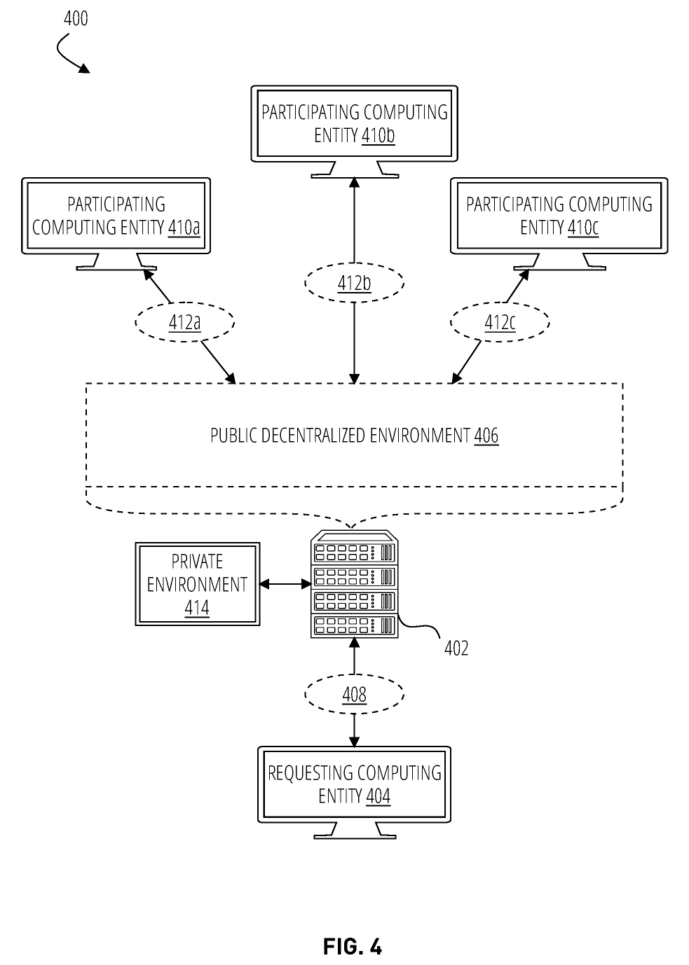

FIG. 1 depicts a block diagram of an example architecture 100 in accordance with some embodiments of the present disclosure. The architecture 100 comprises a computing system 101 configured to receive a requests, such as a data publication requests, information requests, and/or the like, from client computing entities 102, process the request, and provide responses to the client computing entities 102. By way of examples, the computing system 101 may comprise an intermediate computing entity and the client devices may comprise requesting and/or participating computing entities, as described with reference to FIG. 4. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, encryption techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as request logs, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

### A. Example Computing Entity

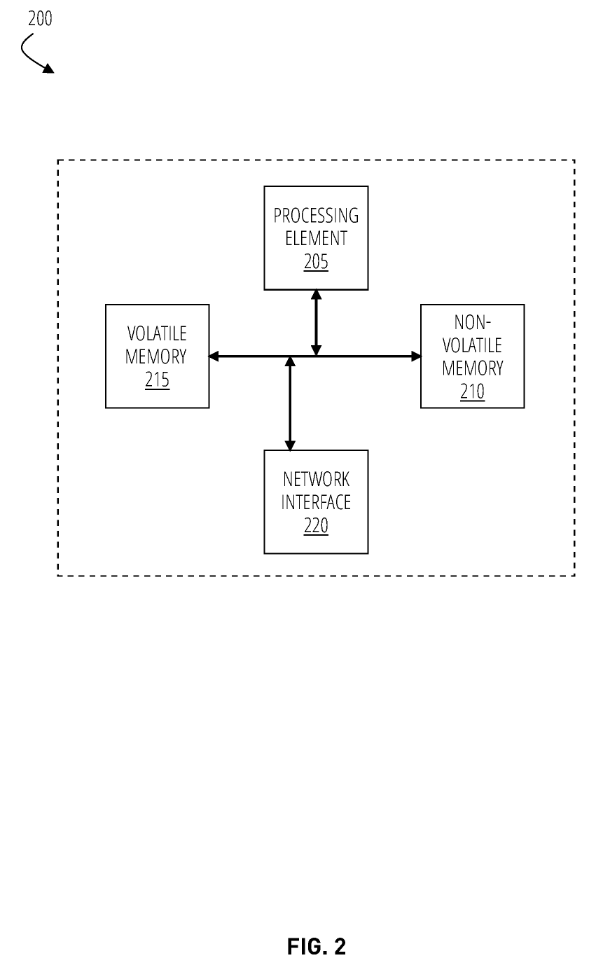

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### B. Example Client Computing Entity

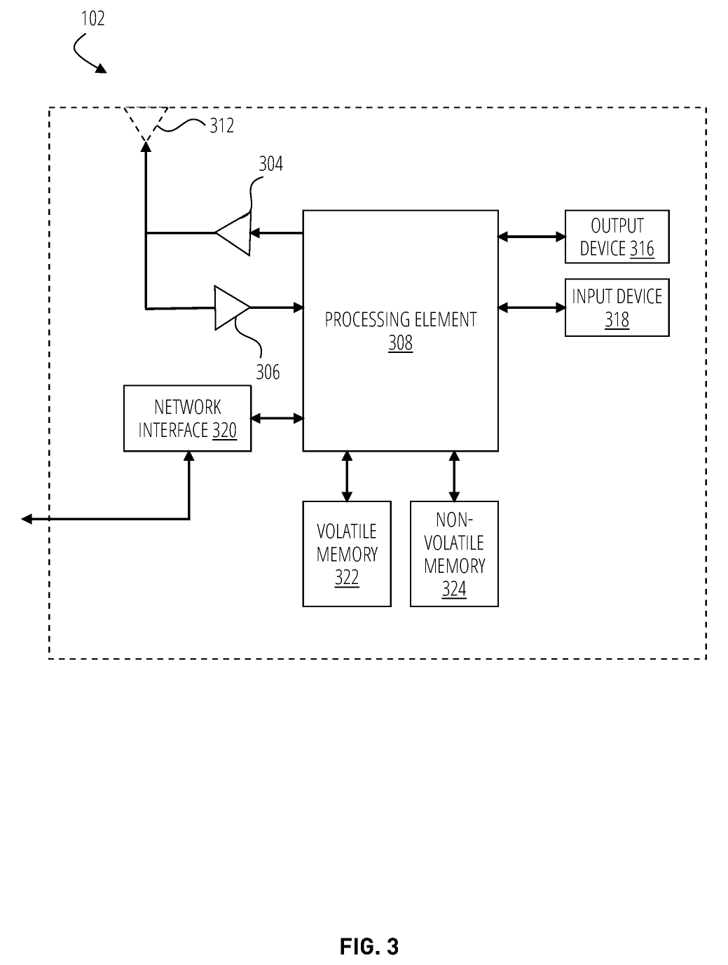

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to data privacy within a networked environment, as well as other computer functionalities. In particular, systems and methods are disclosed herein that implement computing architectures that integrates security infrastructure within a distributed computing environment. By doing so, the computing architectures of the present disclosure enable improved data storage and information sharing that, when executed on a computer, improves the speed, scalability, and security of network communications within an information system. This, in turn, may improve the functionality of a computer with respect to various computing tasks, comprising data security, network communication, and the like.

FIG. 4 is a system diagram of an example computing ecosystem 400 in accordance with some embodiments of the present disclosure. The computing ecosystem 400 comprises a configuration of computing entities specifically arranged to support a secure, incremental encryption-based information system. To do so, the computing ecosystem 400 may comprise an intermediary computing entity 402 that hosts and/or manages a public decentralized environment 406 accessible to a set of preregistered, participating computing entities 410a-c. To instill security measures within the public decentralized environment 406, without inhibiting the participation of the participating computing entities 410a-c, the intermediary computing entity 402 may publish obfuscated portions of a publication within the public decentralized environment 406 that may be tied to an encrypted counterpart within a private environment 414. In this way, the obfuscated portions of a publication may be publicly provided to allow participating computing entities 410a-c to interact with the publication without exposing the sensitive information underlying the publication. Instead, such information may be only provided to a participating computing entity 410a in response to a request and through a secure channel. In this way, the intermediary computing entity 402 enables a secure information system in which a preregistered requesting computing entity 404 may provide sensitive publication to publicly solicit support from a set of participating computing entities 410a-c without exposing the sensitive details of a requested publication. This, in turn, enables the use of the information system in sensitive exchange use cases, such as a healthcare bidding system in which sensitive healthcare member attributes are required to provide tenders for resolving a member's condition, among other use cases that involve protected information that is uniquely susceptible to malicious parties within a networked environment, such as the public decentralized environment 406.

In some embodiments, the intermediary computing entity 402 comprises a computing system, such as the computing system 101 described in FIG. 1, that hosts and/or manages a public decentralized environment 406. The intermediary computing entity 402, for example, may comprise a computing platform that provides a central platform for facilitating network communications between requesting computing entities 404 and participating computing entities 410a-c in a secure and efficient manner. For example, as described herein, the intermediary computing entity 402 may implement an encryption-based infrastructure to enable secure data sharing and processing across distributed networks. This infrastructure may comprise cloud-based servers, distributed databases, secure communication protocols established through entity-specific interfaces (e.g., requesting application programming interfaces (API) 408, participating APIs 412a-c), and/or the like.

In some examples, the intermediary computing entity 402 may employ a combination of blockchain technology and distributed ledger systems to maintain a decentralized and tamper-resistant record of communications (e.g., request logs). In some examples, the intermediary computing entity 402 may leverage smart contracts to automate and/or enforce rules governing data access and sharing between participants. In addition, or alternatively, the intermediary computing entity 402 may implement advanced access control mechanisms, such as role-based access control (RBAC), attribute-based access control (ABAC), and/or the like, to ensure that only authorized entities may access specific data and/or perform certain actions within a public decentralized environment 406.

Using some of the techniques of the present disclosure, the intermediary computing entity 402 may manage data publication within a public decentralized environment 406 to secure data within the public decentralized environment 406 without inhibiting the participation of a participating computing entities 410a-c that are involved in the public decentralized environment 406. To do so, the public decentralized environment 406 may establish a set of requests and responses, as well as, request and response processing protocols for handing the set of requests and responses. For instance, a first set of requests and responses may be defined by a requesting API 408 that may enable a requesting computing entity 404 to securely publish data to a public decentralized environment 406 and interact with responses from a set of participating computing entities 410a-c. As another example, a second set of requests and responses may be defined by a participating API(s) 412a-c that may enable a set of participating computing entities 410a-c to securely interact with a data publication within a public decentralized environment 406. To support these interactions, the public decentralized environment 406 may selectively encrypt and decrypt data within a private environment 414 and forward requests and responses (e.g., with encrypted or decrypted portions of data) between requesting computing entity 404 and the participating computing entities 410a-c while maintaining the integrity and security of the public decentralized environment 406. In this manner, the intermediary computing entity 402 acts as a trusted intermediary, verifying the authenticity of participants and ensuring compliance with predefined security rules and protocols.

In some embodiments, the requesting computing entity 404 is a computing entity that is previously registered with the intermediary computing entity 402 associated with the public decentralized environment 406. The requesting computing entity 404, for example, may comprise a server-based computing system and/or client device, such as the client computing entity 102 of FIG. 1, that communicates with the intermediary computing entity 402 to request the publication of data on its behalf. For example, the requesting computing entity 404 may comprise a computing entity that initiates a data exchange processes within the public decentralized environment 406.

In some examples, the requesting computing entity 404 may be implemented as a client-side application, software module, and/or the like, that interfaces with the intermediary computing entity 402 through a preestablished requesting API 408. The requesting API 408, for example, may be established through a registration process with the intermediary computing entity 402. In some examples, the requesting computing entity 404 incorporates secure communication protocols, such as HTTPS, to establish encrypted connections with the intermediary computing entity 402. It may utilize cryptographic libraries to implement client-side encryption of sensitive data before transmission, employ digital signature algorithms to authenticate its identity and ensure the integrity of the data being sent, and/or the like.

The role of the requesting computing entity 404 may depend on the domain of the computing ecosystem 400. For example, in a clinical domain, such as a healthcare tendering system, the requesting computing entity 404 may comprise a client device of a health care provider (or a member) that is configured to initiate a request for tender (RFT), on behalf of the health care provider's member, to receive offers for treating a particular medical indication. As another example, in a national security domain, such as a defense contractor tendering system, the requesting computing entity 404 may comprise a client device of a government agency that is configured to initiate an RFT to receive offers for completing a government project. Thus, the requesting computing entity 404 may be different for any domain that requires a balance between enhanced security and improved network collaboration relative to traditional public decentralized environments.

In any domain, the requesting computing entity 404 may receive and/or format a data publication request with information for a data publication. To do so, the requesting computing entity 404 may comprise a local databases, a request interface comprising one or more request fields for entering required information, and/or the like. In some examples, the requesting computing entity 404 may packages the information into a structured format, such as JSON or XML, before encrypting it and sending it to the intermediary computing entity 402 for partial publication within the public decentralized environment 406, as described herein. In some examples, the requesting computing entity 404 may incorporate caching mechanisms to store frequently used data and/or API responses locally, reducing network latency and improving overall system performance. It may also implement retry logic and/or error handling to manage network failures or timeouts when communicating with the intermediary computing entity 402 over a requesting API 408.

In some embodiments, the requesting API 408 is a preestablished communication channel between the requesting computing entity 404 and the intermediary computing entity 402. The requesting API 408, for example, may comprise a standardized interface for initiating requests, such as the encrypted data publication requests, response acceptances, and/or the like of the present disclosure, to the intermediary computing entity 402 and/or receiving responses, such as publication responses, and/or the like of the present disclosure, from the intermediary computing entity 402.

The requesting API 408, for example, may comprise RESTful web service, a GraphQL endpoint, a SOAP, JSON-RPC, and/or any other API structure allowing for efficient and scalable communication between distributed systems. The API may utilize HTTP/HTTPS, and/or the like, for data transfer and/or JSON, Protocol Buffers, and/or the like for data serialization. In some examples, to ensure security, the requesting API 408 may implement OAuth 2.0, JWT (JSON Web Tokens), and/or the like, for authentication and authorization.

In some examples, the requesting API 408 may be designed with a defined set of endpoints, each corresponding to specific actions and/or data operations. These endpoints, for example, may comprise methods for submitting new data publication requests, querying the status of existing requests, retrieving responses from participating entities, among others. In some examples, each endpoint may define a request structure for formatting new requests to the intermediary computing entity 402. In this manner, the requesting API 408 may act as a bridge between the requesting computing entity 404 and the intermediary computing entity 402, facilitating the secure exchange of requests and responses, handling the serialization and deserialization of data, managing connection pooling for improved performance, and implementing error handling and/or logging for troubleshooting purposes. By way of example, the requesting API 408 may incorporate rate limiting and request throttling mechanisms to prevent abuse and ensure fair usage among multiple requesting computing entities 404.

In some embodiments, the participating computing entities 410a-c are computing entities that are previously registered with the intermediary computing entity 402 associated with the public decentralized environment 406. The participating computing entities 410a-c, for example, may comprise a server-based computing system and/or client device, such as the client computing entity 102 of FIG. 1, that communicates with the intermediary computing entity 402 to interact with data publications within a public decentralized environment 406. For example, the participating computing entities 410a-c may comprise computing entities that respond within a data exchange process facilitated by the public decentralized environment 406.

In some examples, the participating computing entities 410a-c may be implemented as a client-side applications, software modules, and/or the like, that interface with the intermediary computing entity 402 through preestablished participating APIs 412a-c. The participating APIs 412a-c, for example, may be established through a registration process with the intermediary computing entity 402. In some examples, the participating computing entities 410a-c incorporates secure communication protocols, such as HTTPS, to establish encrypted connections with the intermediary computing entity 402. They may utilize cryptographic libraries to implement client-side encryption of sensitive data before transmission, employ digital signature algorithms to authenticate its identity and ensure the integrity of the data being sent, and/or the like.

The role of the participating computing entities 410a-c may depend on the domain of the computing ecosystem 400. For example, in a clinical domain, such as a healthcare tendering system, the participating computing entities 410a-c may comprise client devices of a pharmaceutical manufacturer, a pharmaceutical wholesaler, a pharmacy, and/or the like, that may respond to an RFT with a tender for treating a particular medical indication (e.g., using a coupon for a medication, an alternative generic version of the medication, a treatment or therapy plan to augment or replace the medication). As another example, in a national security domain, such as a defense contractor tendering system, the participating computing entities 410a-c may comprise client devices of government contractors that may respond to an RFT with a tender for completing a government project (e.g., using a particular process and/or budget not defined by the RFT). Thus, the participating computing entities 410a-c may be different for any domain that requires a balance between enhanced security and improved network collaboration relative to traditional public decentralized environments.

In any domain, the participating computing entities 410a-c may receive and/or format information requests, publication responses, and/or the like with information for responding to a data publication. To do so, the participating computing entities 410a-c may comprise a local databases, a response interface comprising one or more response fields for entering required information, and/or the like. In some examples, the participating computing entities 410a-c may package the information into a structured format, such as JSON or XML, before encrypting it and sending it to the intermediary computing entity 402 for responding to a data publication within the public decentralized environment 406, as described herein. In some examples, the participating computing entities 410a-c may incorporate caching mechanisms to store frequently used data and/or API responses locally, reducing network latency and improving overall system performance. They may also implement retry logic and/or error handling to manage network failures or timeouts when communicating with the intermediary computing entity 402 over participating APIs 412a-c.

In some embodiments, the participating APIs 412a-c are a preestablished communication channels between the participating computing entities 410a-c and the intermediary computing entity 402. For example, up to each participating computing entity of the set of participating computing entities 410a-c may communicate with the intermediary computing entity 402 via a unique participating API (e.g., with a cryptographic technique and/or key specific to the participating computing entity). In addition, or alternatively, up to each of the set of participating computing entities 410a-c may communicate with the intermediary computing entity 402 via the same participating API.

The participating APIs 412a-c may comprise a standardized interface for initiating requests/responses, such as the information requests, publication responses, and/or the like of the present disclosure, to the intermediary computing entity 402 and/or receiving responses, such as information responses, and/or the like of the present disclosure, from the intermediary computing entity 402. The participating APIs 412a-c, for example, may comprise RESTful web service, a GraphQL endpoint, a SOAP, JSON-RPC, and/or any other API structure allowing for efficient and scalable communication between distributed systems. The API may utilize HTTP/HTTPS, and/or the like, for data transfer and/or JSON, Protocol Buffers, and/or the like for data serialization. In some examples, to ensure security, the participating APIs 412a-c may implement OAuth 2.0, JWT (JSON Web Tokens), and/or the like, for authentication and authorization.

In some examples, the participating APIs 412a-c may be designed with a defined set of endpoints, each corresponding to specific actions and/or data operations. These endpoints, for example, may comprise methods for submitting new publication responses, querying the status of existing responses, retrieving information responses from participating entities, among others. In some examples, each endpoint may define a request structure for formatting new requests/responses to the intermediary computing entity 402. In this manner, the participating APIs 412a-c may act as a bridge between the participating computing entities 410a-c and the intermediary computing entity 402, facilitating the secure exchange of requests and responses, handling the serialization and deserialization of data, managing connection pooling for improved performance, and implementing error handling and/or logging for troubleshooting purposes. By way of example, the participating APIs 412a-c may incorporate rate limiting and request throttling mechanisms to prevent abuse and ensure fair usage among multiple participating computing entities 410a-c.

In some embodiments, the public decentralized environment 406 comprises a cloud-based environment that is accessible to a set of participating computing entities 410a-c. The public decentralized environment 406, for example, may comprise a shared infrastructure for facilitating secure and transparent information exchange between multiple parties. In some examples, the public decentralized environment 406 may comprise blockchain-based distributed storage system that is facilitated across the set of participating computing entities 410a-c and the intermediary computing entity 402. The blockchain component, for example, may use consensus algorithms such as Proof of Stake, Practical Byzantine Fault Tolerance, and/or the like, to ensure agreement on the state of shared data across the network. In some examples, the distributed storage may be implemented using protocols like IPFS (InterPlanetary File System), Swarm, and/or the like for efficient and resilient data storage and retrieval. Due to its distributed nature, the public decentralized environment 406 may present security risks for sensitive information. To combat these risks, without reducing the benefits provided by blockchain and distributed storage technologies, the public decentralized environment 406 may be paired with a private environment 414 that may be used to selectively augment the information within the public decentralized environment 406 through individual, secure channels.

In some examples, the public decentralized environment 406 comprises a set of networking and/or data synchronization mechanisms, such as peer discovery protocols, data propagation algorithms, and/or conflict resolution strategies to handle concurrent updates. For instance, the public decentralized environment 406 may employ sharding techniques to improve scalability, allowing different subsets of the network to process different data publications, concurrently. In this way, the public decentralized environment 406 provides a shared, tamper-resistant record of all data publications and subsequent interactions and ensures transparency and auditability of a tendering process while maintaining the privacy and security of the sensitive information underlying the tendering process. In a clinical context, this environment allows healthcare providers, pharmacies, and other stakeholders to participate in prescription tendering without relying on a centralized authority.

In some embodiments, the private environment 414 is a closed environment that is subject to a set of security measures and only accessible to an intermediary computing entity 402. It may comprise a local storage, private cloud workspace, and/or the like, for the intermediary computing entity 402. By way of example, the private environment 414 may comprise a secure enclave for storing and/or processing highly sensitive information outside of the public decentralized environment 406. When combined with the public decentralized environment 406, the private environment 414 provides a combination of encryption and data distribution functionalities that allow for tracked multi-party interactions without exposing the sensitive information underlying the interactions.

The private environment 414 may comprise a combination of secure hardware and/or software solutions to ensure data security. This may comprise the use of Hardware Security Modules (HSMs) for cryptographic operations and secure key storage, isolated network segments protected by advanced firewalls and intrusion detection systems, encrypted storage systems for data at rest, and/or the like. In some examples, the private environment 414 may enforce strict access control mechanisms and comprehensive auditing systems. By way of example, the private environment 414 may require multi-factor authentication for all access attempts, role-based access control (RBAC) to limit data visibility based on user roles, detailed logging of all operations performed within the environment, and/or the like. In some examples, the system may employ data isolation techniques, such as containerization or virtual machine enclaves to segregate information by data publication. For example, up to each data publication request may be stored within an isolated container mechanism to separate data publications from each other within the private environment 414. In addition, or alternatively, up to each data publication request may be stored within an isolated container mechanism for a corresponding requesting computing entity 404 to separate data publications of respective requesting computing entities 404 from each other within the private environment 414.

In this way, the private environment 414 may provide a secure space for the intermediary computing entity 402 to perform sensitive operations, such as the decryption of encrypted data publication requests, storage of private keys, processing of confidential information, and/or the like. In some examples, the private environment 414 may ensures that critical security operations and/or sensitive data remain protected from unauthorized access, even in the event of a breach in the public decentralized environment 406. In some examples, the private environment 414 may support a distributed environment where sensitive operations may be split across multiple secure enclaves, potentially operated by different trusted entities. This approach may provide additional resilience and reduce single points of failure. The intermediary computing entity 402 may incorporate secure multi-party computation techniques to allow certain operations on sensitive data without exposing the data itself, even within the private environment 414.

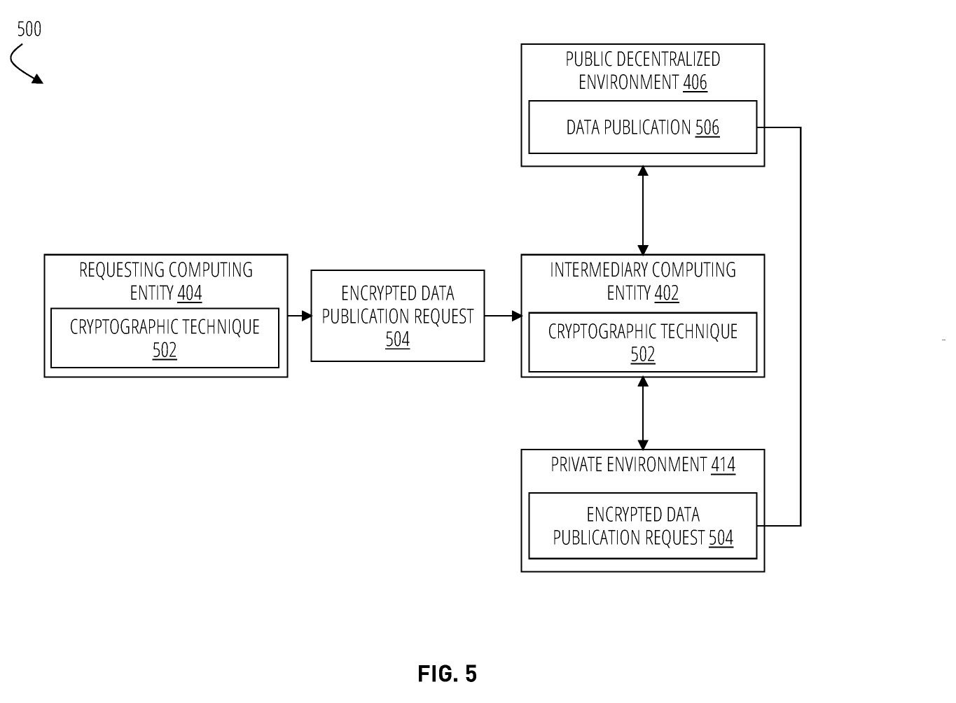

FIG. 5 is a dataflow diagram of a secure partial data publication technique 500 in accordance with some embodiments of the present disclosure. The secure partial data publication technique 500 may be implemented by a computing system, such as the computing system 101 and/or intermediary computing entity 402, to implement security measures within a public decentralized environment 406 that increase the data security without reducing the efficacy of the public decentralized environment 406. To do so, the secure partial data publication technique 500 may process an encrypted data publication request 504 to remove sensitive information before publishing the request to a public decentralized environment 406. Once published, the data publication 506 resulting from the encrypted data publication request 504 may linked to the encrypted data publication request 504 within a private environment 414 to enable the selective provisioning of sensitive information through secure channels outside of the public decentralized environment 406. In this manner, the secure partial data publication technique 500 enables the secure publication of secure data within a public decentralized environment 406 without disassociating the data from the sensitive information underlying the data publication 506. This, in turn, allows the use of a public decentralized environment 406, that is inherently unsecure from a data privacy perspective, for secure data exchanges by integrating encryption infrastructure within a private environment 414 adjacent to the public decentralized environment 406.

In some embodiments, the intermediary computing entity 402 receives from a requesting computing entity 404, an encrypted data publication request 504. In some examples, the encrypted data publication request 504 may be encrypted using a cryptographic technique 502 shared between the requesting computing entity 404 and the intermediary computing entity 402. As an example, the cryptographic technique 502 may comprise an asymmetric key encryption technique and the encrypted data publication request 504 may be encrypted using a public key shared by the intermediary computing entity 402 and decrypted using a private key corresponding to the public key. However, other cryptographic techniques may also be employed.

In some embodiments, the encrypted data publication request 504 is a request to publish a data publication 506 on behalf of a member. The encrypted data publication request 504 may comprise an encrypted message that may be generated, encrypted, and provided using one or more endpoints of a requesting API configured at the requesting computing entity 404. The requesting API, for example, may define a cryptographic technique 502 (e.g., defined, designated, and/or shared by the intermediary computing entity 402) and the encrypted data publication request 504 may be encrypted according to the cryptographic techniques 502 to secure one or more protected attributes of an underlying data publication request. In this manner, the encrypted data publication request 504 may serve as a secure container for transmitting protected attributes adjacent to a public decentralized environment 406.

As described herein, the encrypted data publication request 504 may be generated, at the requesting computing entity 404, using one or more encryption algorithms established by the cryptographic technique 502, such as AES (Advanced Encryption Standard) for symmetric encryption, RSA (Rivest-Shamir-Adleman) for asymmetric encryption, and/or the like. The encryption process may prescribe multiple layers of security, such as data padding, initialization vectors, digital signatures, and/or the like, to ensure the confidentiality, integrity, and authenticity of the encrypted data publication request 504. By way of example, the encryption of the encrypted data publication request 504 may be performed on the client-side (e.g., by the requesting computing entity 404) before transmission to the intermediary computing entity 402. This approach may ensure that sensitive data remains protected even if intercepted during transmission. In some examples, the encrypted data publication request 504 may be further secured using transport layer security (TLS) protocols during transmission over the network.

In any case, the encrypted data publication request 504 may enable the secure sharing of sensitive information, such as member identifiers, demographic attributes, and/or other confidential details, over a network without exposing them to unauthorized parties. For example, the encrypted data publication request 504 may ensure that only entities (e.g., the intermediary computing entity 402) with an appropriate decryption keys may access the underlying information. In addition, or alternatively, the encrypted data publication request 504 may comprise a homomorphic encryption technique, allowing certain computations to be performed on the encrypted data without decrypting it. In any approach, the encrypted data publication request 504 may enable advanced privacy-preserving data processing by the intermediary computing entity 402 before adding a request to a public decentralized environment 406.

In some embodiments, the cryptographic technique 502 to an established methodology used to encrypt requests and/or responses transmitted between entities affiliated with the intermediary computing entity 402. The cryptographic technique 502, for example, may comprise a methodology that may be controlled and shared by the intermediary computing entity 402 to establish consistent security measures across a computing ecosystem by providing a foundation for securing sensitive information exchanged within the computing ecosystem.

The cryptographic technique 502 may comprise a range of encryption algorithms and/or protocols, such as symmetric encryption algorithms, such as AES for bulk data encryption, asymmetric encryption algorithms, such as RSA, Elliptic Curve Cryptography (ECC) for key exchange and digital signatures, and/or the like. In addition, or alternatively, the cryptographic technique 502 may comprise a cryptographic hash function, such as SHA-256 for data integrity verification, and/or the like.

In some examples, the cryptographic technique 502 may comprise key-based encryption technique that may be established through secure key generation, storage, and distribution across a set of affiliated entities. For example, the intermediary computing entity 402 may generate a public and/or private encryption key for up to each affiliated entity (e.g., requesting computing entity 404, participating computing entity 410a-c) with n a computing ecosystem. By way of example, up to each of the affiliated entities may be issued an individual public or private key. In addition, or alternatively, one or more of the affiliated entities may be issued the same public key. In either case, the cryptographic technique 502 may be implemented by the intermediary computing entity 402, the requesting computing entity 404, and/or participating computing entities 410a-c using a Hardware Security Modules (HSMs) for high-security key storage and operations.

As one example, the cryptographic technique 502 may comprise an asymmetric key encryption technique. The asymmetric key encryption technique, also known as a public-key cryptography, may utilize a pair of mathematically related keys - a public key and a private key - to encrypt and decrypt data. The asymmetric key encryption technique may be typically implemented using algorithms such as RSA, ECC, and/or the like, and may be facilitated by the intermediary computing entity 402 by generating key pairs (e.g., one for each affiliated entity, one for each group of affiliated entities, one for all affiliated entities), securely storing private keys within the private environment 414, and distributing public keys to relevant parties.

In some embodiments, a public key is a public key that is shared between the intermediary computing entity 402 and up to each requesting computing entity 404 and participating computing entity 410a-c affiliated with the intermediary computing entity 402. The public key, for example, may be issued to an affiliated entity during a registration process. In addition, or alternatively, the public key may be generated, on demand, in response to a call from a requesting API and/or participating API. By way of example, a public key may be specific to the intermediary computing entity 402 (e.g., one key for all affiliated entities), specific to an affiliated entity (e.g., one key for each individual (or a group of) affiliated entity), and/or specific to a particular request (e.g., one key for each encrypted data publication request 504). In any case, the public key provides an externally available component of the asymmetric encryption system, enabling secure communication and data verification between an affiliated entity and the intermediary computing entity 402.

A public key may comprise any key format, such as a large numerical value, a string of characters, and/or the like. In some examples, the intermediary computing entity 402 may generate the public key using prime number factorization (e.g., in the case of RSA), elliptic curve discrete logarithm problems (e.g., in the case of ECC), and/or the like. Once generated, a public key may be stored in standardized formats, such as X.509 certificates, PEM (Privacy Enhanced Mail) files, and/or the like. In some examples, the storage format may comprise the public key itself and/or metadata about the key's owner, validity period, intended use, and/or the like.

In some embodiments, the private key comprises a counterpart to a public key that is hidden from external parties, such as the requesting computing entity 404 and/or participating computing entities 410a-c.

A private key may comprise any key format, such as a large numerical value, a string of characters, and/or the like. In some examples, the intermediary computing entity 402 may generate the private key using prime number factorization (e.g., in the case of RSA), elliptic curve discrete logarithm problems (e.g., in the case of ECC), and/or the like. Once generated, a private key may be stored in standardized formats, such as X.509 certificates, PEM (Privacy Enhanced Mail) files, and/or the like. In some examples, the storage format may comprise the private itself and/or metadata about the corresponding public key's owner, validity period, intended use, and/or the like.

In some embodiments, the intermediary computing entity 402 decrypts the encrypted data publication request 504 to receive a data publication request. The data publication request may comprise a request to publish a data publication 506 and/or one or more sensitive attributes underlying the data publication 506. For instance, the data publication request may identify (a) a target entity, (b) a set of entity attributes, (c) a condition, and/or (d) an assigned correction for the condition. In some examples, the target entity and/or one or more of the set of entity attributes may comprise protected information, whereas other portions of the data publication request may comprise unprotected attributes, such as a disassociated condition and/or assigned correction that may provide actionable information for a set of participating computing entities 410a-c.

More particularly, in some embodiments, the data publication request may comprise a request to post a data publication 506 to a public decentralized environment 406. The data publication request may provide a primary mechanism for initiating the sharing of information within the public decentralized environment 406, while comprising protected attributes that require security measures exceeding those offered by the public decentralized environment 406.

By way of example, the data publication request may comprise a structured object, such as a JSON (JavaScript Object Notation), Protocol Buffers, and/or the like, that encapsulates a set of attributes of a data publication request, comprising identifiers, metadata, and/or the like. The structure of the data publication request may be defined using schema languages, such as JSON Schema, Protocol Buffers’. proto files, and/or the like, to ensure consistency and enable validation. In some examples, the data schemas of the data publication request may be defined by an API endpoint of the requesting API.

In some examples, the data publication request initiates and supports the process of incrementally sharing information within the public decentralized environment 406 and/or adjacent side channels established by the intermediary computing entity 402. In this respect, the data publication request may provide both protected and unprotected data relevant to a particular data publication. This, in turn, mandates a divided level of security for the data publication request that requires different security measures for different portions of the data publication request. This divided level of security is accomplished through the incremental decryption techniques of the present disclosure, in which portions of the data publication request are separated and individually sent, either through the public decentralized environment 406 or through an adjacent secure channel according to the protected characteristics of the data.

In some embodiments, the data publication request corresponds to a target entity. A target entity may comprise an entity that has a condition for which data publication request is designed to resolve. The target entity, for example, may represent the subject and/or beneficiary of an information exchange facilitated by the intermediary computing entity 402. In some examples, the target entity may be represented within a system as a data object or record in a database. This representation may comprise various attributes, such as unique identifiers, demographic information, historical data, current status, and/or the like. The entity, and/or the attributes thereof, may depend on the domain. For example, in a clinical domain, such as a healthcare tendering system, the target entity may comprise a patient, a member of a healthcare plan, and/or the like that is diagnosed with a conditions, such a clinical indication that may be corrected using a prescribed medication, treatment plan, or therapy regime. As another example, in a national security domain, such as a defense contractor tendering system, the target entity may comprise an industry, technology area, threat, or the like, that presents a technical problem or initiative.

In some embodiments, the data publication request comprises a set of entity attributes associated with the target entity. An entity attribute may comprise any relevant information for a target entity, comprising a geographic location (e.g., home or work address), demographics, health care history, and other information that may improve a recommendation for a correction, but, in some cases, may require enhanced security measures due to data sensitivities. Entity attributes, for example, may provide context for tailoring publication responses and ensuring the appropriateness of proposed corrections to a posted condition.

The entity attributes may depend on the domain. For example, in a clinical domain, such as a healthcare tendering system, the entity attributes may comprise geographic attributes, demographics, or health related attributes, such as a target entity's clinical history, previous or ongoing indications, and/or any other information that may inform a diagnosis for a condition of the data publication 506. By way of example, the entity attributes may comprise sensitive attributes, such as biomarkers, patient reported outcomes, adverse effects, treatment adherence, adjunct therapies, and/or the like that may impact a treatment recommendation. As another example, in a national security domain, such as a defense contractor tendering system, the entity attributes may comprise geographic attributes, a technology focus, and/or any other information that may inform the reasoning for a condition of the data publication 506.

In some embodiments, the data publication request identifies a condition associated with the target entity. The condition, for example, may identify an aspect of the target entity for which the data publication requests a correction to address. By way of example, the condition may represent a problem for which a RFT is provided. The condition may depend on the domain. For instance, in a clinical context, the condition may comprise a clinical indication, such as an ICD-10 code (International Classification of Diseases, 10th revision), SNOMED CT code (Systematized Nomenclature of Medicine -- Clinical Terms), and/or the like that describes a diagnosed condition for the target entity. As another example, in a national security domain, such as a defense contractor tendering system, the condition may comprise deliverable that describes an end goal for the target entity. In any domain, a condition serves as a key component in defining the nature and purpose of data publications within the public decentralized environment 406 and that may be protect if associated with the target entity and/or other entity attributes of the data publication request but unprotected if disassociated from the target entity and/or the other entity attributes of the data publication request.

In some embodiments, the data publication request comprises a set of condition criteria for correcting the condition. The set of condition criteria may describe a set of attributes for constraining a publication response that addresses a condition of a data publication. By providing condition criteria, in addition to the condition, a data publication request may provide a mechanism for modifying an assigned correction with an alternative correction. This allows the participating computing entities of the public decentralized environment 406 to provide alternative responses to a data publication request, rather than constraining the responses to a single requested mechanism. By doing so, the set of condition criteria may expand the flexibility of the public decentralized environment 406 beyond traditional approaches by encouraging alternatives to a request. This added flexibility may be particularly useful in use cases in which an assigned correction may be one of several options for handling a condition, such as in a clinical domain in which a diagnosed condition may have many potential remedies. By way of example, staying with the clinical use case, the condition criteria may comprise a subdivided set of medical criteria and non-medical criteria for any proposed correction. The non-medical criteria may comprise a location preference (e.g., medication refills at a dispensing pharmacy near a place of work), a mail order preference (e.g., a preference for mail order fulfilment), and/or the like. The medical criteria may comprise a relative preferences for symptoms reduction, quality of life, and/or the like. In this manner, the set of condition criteria may inform a participating computing entity on how to construct a publication response without exposing sensitive information underlying a data publication 506.

In some embodiments, the data publication request identifies an assigned correction associated with the target entity. In some examples, the assigned correction is a remedial action for remediating a condition that is proposed by the data publication request. In the clinical context, this may comprise a prescription, a therapy recommendation, and the like, that is prescribed by a healthcare provider. In any domain, the assigned correction represents an initial proposed solution or intervention for addressing the identified condition. The assigned correction, for example, may provide a baseline and/or starting point for the tendering process, in which participating computing entities may bid on the value of the assigned correction or offer an alternative correction based on the set of correction criteria. Unlike traditional bidding approaches, the assigned correction of a data publication 506 may serve as just one input to a publication response, rather than constraining the response to a particular item. This flexibility allows for increase complexity within the public decentralized environment 406 that may be facilitated through secure information transfers, as described herein.

In some embodiments, the intermediary computing entity 402 generates data publication 506 based on a first portion of the data publication request. In some examples, the first portion of the data publication request comprises the condition and the assigned correction. The data publication, for example, may comprise a published version of a data publication request that may be visible to a set of participating computing entities through the public decentralized environment 406. In this respect, the data publication 506 may comprise a portion of information from the data publication request that is sufficient to gauge a response without exposing sensitive information of the target entity. In this way, the data publication 506 may serve as a communication tool for sharing information within the public decentralized environment 406.

In some examples, a data publication may comprise an immutable data object stored in a distributed ledger and/or blockchain system. This ensures the integrity and traceability of published information. The data structure of a publication may use a standardized format such as JSON-LD (JSON for Linked Data) to provide semantic context and enable interoperability across different systems. In some example, the creation and/or management of data publications 506 may involve several processes, such as data extraction and/or anonymization from the data publication request, generation of unique identifiers for the data publication (e.g., a publication identifier), the application of access control policies to determine which parts of the publication are visible to different participants, and/or the like.

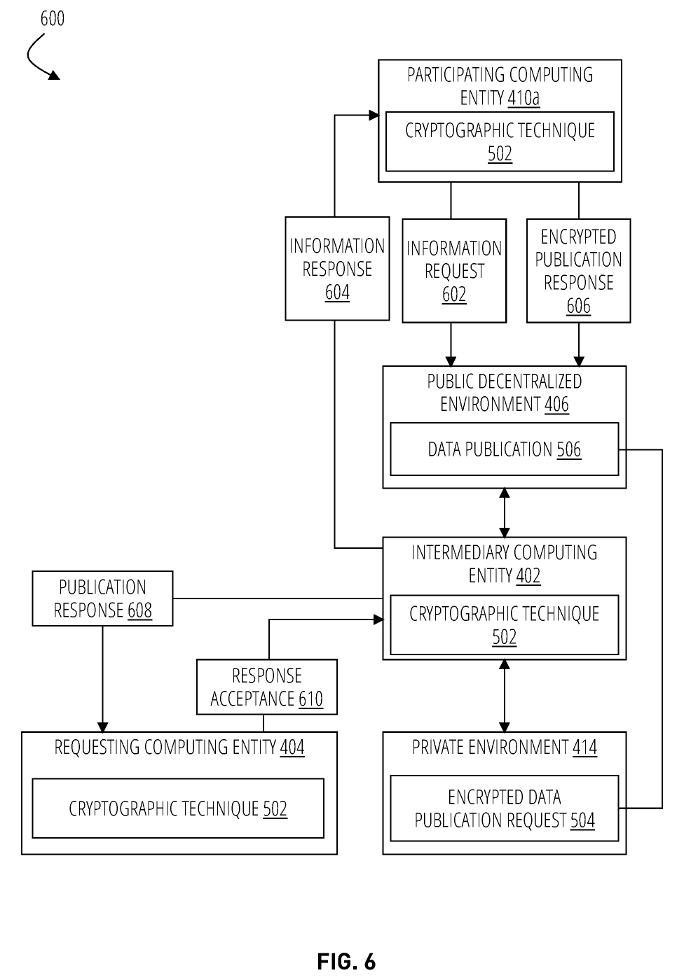

By way of example, the data publication 506 may comprise at least one of the condition, the assigned correction, and/or the set of correction criteria from the data publication request. The at least one of the condition, the assigned correction, and/or the set of correction criteria may posted in a manner that disassociates the data from the target entity and/or entity attributes that may expose the protected information of the target entity. In this way, the data publication may act as a catalyst for responses within the public decentralized environment 406, without presenting data security risks to the target entity. For example, the at least one of the condition, the assigned correction, and/or the set of correction criteria from the data publication request may provide participating computing entities with the necessary information to formulate relevant and appropriate publication responses and/or to request additional information through information requests, as described with reference to FIG. 6.

In some examples, the data publication 506 may comprise one or more anonymize entity attribute to further support a publication response process. By way of example, in a clinical context, a data publication 506 may comprise anonymized patient demographics, the condition being treated, and the general class of medication required, a generalized location (e.g., at state, city, or geographic bounding box level), without revealing personally identifiable information. In addition, or alternatively, the data publication 506 may comprise a tiered data publication, where additional details may be revealed to participants as they progress through different stages of the response process.

In some embodiments, the intermediary computing entity 402 stores the data publication 506 within a public decentralized environment 406 accessible to a set of participating computing entities 410a-c. In some examples, the data publication 506 comprises an interactive element configured to initiate an information request and/or a publication response, as described with reference to FIG. 6. The interactive element, for example, may trigger an API call from a participating API to initiate a request and/or response from the participating computing entity to the intermediary computing entity 402. In this manner, the data publication 506 may facilitate communications between the intermediary computing entity 402 and/or the participating computing entities with access to the public decentralized environment 406.

In some embodiments, the intermediary computing entity 402 encrypts the data publication request to regenerate the encrypted data publication request 504 and stores the encrypted data publication request 504 within a private environment 414 with an association to the data publication 506. By way of example, the intermediary computing entity 402 may assign a publication identifier to the data publication 506 and store the encrypted data publication request 504 in association with the publication identifier. For instance, the intermediary computing entity 402 may link the data publication 506 to the encrypted data publication request 504 by assigning the publication identifier to each of the data publication 506 and the encrypted data publication request 504. In addition, or alternatively, the publication identifier may comprise a link to the encrypted data publication request 504 and/or the data publication 506 that may encapsulate a storage location of the encrypted data publication request 504 and/or the data publication 506.

In some embodiments, the publication identifier comprises to a numerical, alpha-numerical, and/or any other identifier that may uniquely identify a data publication request, a data publication 506 based on the data publication request, and/or an encrypted data publication request 504 of the data publication request. The publication identifier, for example, may comprise a reference point for tracking and/or managing individual data publications 506 within the public decentralized environment 406 and linking the data publications 506 within the public decentralized environment 406 to encrypted information within the intermediary computing entity's 402 private environment 414.

By way of example, the publication identifier may comprise a UUID (Universally Unique Identifier), a sequential numbering systems with prefixes to denote different publication types or sources, or cryptographic hash applied to the content of the publication, and/or the like. In addition, or alternatively, the intermediary computing entity 402 may incorporate timestamp information and/or other metadata into the identifier generation process to provide additional context for the publication identifier.

In some embodiments, the publication identifier is accessible to the set of participating computing entities through the data publication 506. For example, the publication identifier may be visually rendered within the data publication 506. In addition, or alternatively, the publication identifier may be embedded within an interactive element to enable the automatic population of the publication identifier within communications between the participating computing entity and the intermediary computing entity 402. By doing so, the publication identifier may facilitate requests and responses between the participating computing entities and the intermediary computing entity 402 to enable an incremental information process for securely responding to a data publication 506, as described further with reference to FIG. 6.

FIG. 6 is a dataflow diagram of a secure publication processing technique 600 in accordance with some embodiments of the present disclosure. The secure publication processing technique 600 may be implemented by a computing system, such as the computing system 101 and/or intermediary computing entity 402, to maintain security measures within a public decentralized environment 406 that increase the data security without reducing the efficacy of the public decentralized environment 406. To do so, the secure publication processing technique 600 may implement an incremental data provisioning approach to selectively provide protected information, corresponding to a data publication 506 within a public decentralized environment 406, through secure side-channels of the public decentralized environment 406. For example, the secure publication processing technique 600 may support information requests 602 from participating computing entities, such as the participating computing entity 410a, that may be used to decrypt data within a private environment 414, extract a portion of the data, and transfer the extracted data to the participating computing entity 410a to supplement a data publication 506 within the public decentralized environment 406 without exposing the data to the public decentralized environment 406. In this way, the secure publication processing technique 600 enables the selective provisioning of sensitive information through secure channels outside of the public decentralized environment 406, which, in turn, allows the use of a public decentralized environment 406, that is inherently unsecure from a data privacy perspective, for secure data exchanges by integrating encryption infrastructure within a private environment 414 adjacent to the public decentralized environment 406.

In some embodiments, the intermediary computing entity 402 receives from a participating computing entity 410a of the set of participating computing entities 410a-c, an information request 602 that identifies the data publication 506. The information request 602, for example, may comprise the publication identifier of the data publication 506. In some examples, the information request 602 may be provided through an interaction with an interactive element of the data publication 506.

In some embodiments, the interactive element is an interactive button or other interface element that initiates an API call between a participating computing entity 410a and the intermediary computing entity 402. The interactive element, for example, may be rendered as part of a web application, embedded within native mobile application, and/or the like. In some examples, the interactivity of the interactive element may be provided by event listeners that trigger specific actions when interacted with, such as making asynchronous API calls using technologies like XMLHttpRequest, the Fetch API, and/or the like.

In some examples, the interactive element may comprise one or more frontend and/or backend attributes. On the frontend, the interactive element may comprise an element state (e.g., enabled/disabled, loading) that control an interactivity of the interactive element, an element position (e.g., coordinates within a rendering of a data publication), an element label, and/or the like. On the backend, the interactive element may comprise an API calls triggered by the interactive element. In some examples, the attributes of the interactive element may correspond to a particular request and/or response within a participating API. For example, a first interactive element may be configured for an information request 602 and may correspond to an API call that triggers the information request 602. In addition, or alternatively, a second interactive element may be configured for an encrypted publication response 606 and may correspond to an API call that triggers the encrypted publication response 606. In this manner, a data publication 506 may define a set of interactive elements that collectively trigger one or more of set of API endpoints within a participating API. In some examples, the first interactive element may be selected to trigger the information request 602 (and/or one or more subsequent information requests 602 as described herein).

In some embodiments, an information request 602 is an API call between the participating computing entity 410a and the intermediary computing entity 402 that requests additional, hidden information for a data publication 506. The information request 602 serves as a mechanism for participating computing entities to obtain more detailed and/or sensitive information about a data publication when formulating their responses, without exposing the information to the public decentralized environment 406. The information request 602, for example, may comprise a RESTful API endpoint, GraphQL query, and/or the like. In some examples, the information request 602 may be authenticated using mechanisms such as API keys, OAuth tokens, JSON Web Tokens (JWTs), and/or the like, to authenticate a provider of the information request 602.

In some embodiments, the information request 602 comprises at least one of a request index, the publication identifier, an identifier of the participating computing entity 410a, and/or one or more requested attributes. The request index, for example, may identify the number of requests issued for a particular data publication 506. For instance, the request index may identify the information request 602 as an initial information request (e.g., the first request from the participating computing entity 410a for the data publication 506), a subsequent information request 602 (e.g., the second request from the participating computing entity 410a for the data publication 506), a third information request 602 (e.g., the third request from the participating computing entity 410a for the data publication 506), and/or the like. The publication identifier may identify the data publication 506, the encrypted data publication request 504, and/or data publication request, as described herein. The identifier of the participating computing entity 410a may comprise a unique identifier (e.g., a UUID, a randomly assigned identifier during registration, a username) of the participating computing entity 410a.

Up to each of these identifiers may be leveraged by the intermediary computing entity 402 to track communications between the participating computing entity 410a with respect to the data publication 506. By way of example, information request 602, and/or the identifiers thereof, may be stored within a request log corresponding to the data publication 506. The request log, for example, may comprise a record of transactions within, and/or adjacent to, the public decentralized environment 406 that may provide a comprehensive audit trail of all activities and interactions that occur with respect to a data publication 506 without exposing the sensitive information underlying the data publication 506. By way of example, the request log may comprise a distributed ledger and/or blockchain structure, in which each transaction, such as a data publication request, information request, or publication response, is recorded as a new block in the chain.

In some embodiments, the intermediary computing entity 402 modifies the request log corresponding to the data publication 506 in response to an information request 602. For example, the intermediary computing entity 402 may post a record a new block (e.g., comprising the identifiers and/ requested attributes of the information request) within the chain that may be authenticated by the participating computing entities 410a-c affiliated with the public decentralized environment 406.

In some embodiments, a requested attribute of the information request 602 identifies specific hidden information that is requested by the participating computing entity 410a for responding to the data publication 506. A requested attribute, for example, may represent particular pieces of sensitive and/or detailed information that may be obfuscated from a data publication and instead encrypted within an associated encrypted data publication request 504. By way of example, the requested attribute may identify one or more types of entity attributes that may be present within the encrypted data publication request 504, such as a request for one or more biomarkers, patient reported outcomes, adverse effects, treatment adherence, adjunct therapies, and/or the like. In some examples, the requested attribute may request all available information with respect to an attribute category (e.g., demographic category, clinical history category, geographic category). In addition, or alternatively, the requested attribute may comprise a request to confirm or deny an assertion associated with a particular entity attribute (e.g., confirm or deny if a particular biomarker is present). In the case of the former, the information request 602 may be processed by decrypting the encrypted data publication request 504, extracting the requested information, and providing the requested information to the participating computing entity 410a (e.g., in an encrypted or unencrypted form). In the case of the later, the information request 602 may be processed by decrypting the encrypted data publication request 504, extracting the requested information, processing the assertion based on the extracted information, and providing responses to the assertions instead of the underlying sensitive information to the participating computing entity 410a (e.g., in an encrypted or unencrypted form).

In either case, the requested attributes allow participating computing entities 410a to obtain specific, relevant information needed to tailor their responses to a data publication 506 without exposing the information to a public decentralized environment 406. By way of example, in a prescription tendering scenario, a requested attribute may request information on a patient's allergies or current medications, which may inform an alternative prescription offered by a participating pharmacy.

In some embodiments, in response to the request, the intermediary computing entity 402 decrypts the encrypted data publication request 504 to receive the data publication request. For example, the intermediary computing entity 402 may identify the encrypted data publication request 504 based on the publication identifier and apply the cryptographic technique 502 to the encrypted data publication request 504 to receive the data publication request. The intermediary computing entity 402 may generate an information response 604 based on a second portion of the data publication request. The second portion, for example, may comprise a first subset of the set of entity attributes. By way of example, the information request 602 may comprise one or more requested attributes, and the first subset of the set of entity attributes may be determined based on the initial requested attribute.

In some embodiments, the information response 604 is an API response between a participating computing entity 410a and the intermediary computing entity 402 that provides additional, hidden information for a data publication 506. The information response serves as the mechanism for delivering requested attributes, and/or responses to assertion regarding the requested attributes, to authorized participating entities. The information response 604, for example, may comprise a JSON, XML payload, and/or the like that may encapsulate a subset of entity attributes and/or assertion responses (e.g., binary responses, categorical responses) regarding the subset of entity attributes. In addition, or alternatively, the information response 604 may comprise response metadata, such as timestamps, the identifier of the participating computing entity 410a, the request index, data provenance information, usage restrictions, and/or the like. In some examples, the information response 604 may be added to the request log by storing the metadata of the information response 604, rather than the subset of entity attributes and/or assertion responses to prevent the exposure of protected information to the public decentralized environment 406.

In some embodiments, the intermediary computing entity 402 provides the information response 604 to the participating computing entity 410a. For example, the intermediary computing entity 402 may provide, via the participating API, the information response 604 to the participating computing entity 410a. The information response 604 may be provided in an unencrypted and/or encrypted manner. By way of example, if encrypted, the encrypted information response 604 may be decrypted by a previously, and/or concurrently, issued decryption key stored internally by the participating computing entity 410a and/or accessible via an endpoint of the participating API.

In some embodiments, the intermediary computing entity 402 receives, from the participating computing entity 410a, a subsequent information request 602 that identifies the data publication and comprises a subsequent requested attribute different than the initial requested attribute. In response to the subsequent information request 602, the intermediary computing entity 402 may decrypt the encrypted data publication request 504 to receive the data publication request. The intermediary computing entity 402 may generate, based on the subsequent requested attribute, a subsequent information response 604 based on a third portion of the data publication request that comprises a second subset of the set of entity attributes. The intermediary computing entity 402 may provide the subsequent information request 602 to the participating computing entity, encrypt the data publication request to regenerate the encrypted data publication request 504, and store the encrypted data publication request 504 within the private environment 414 with an indication of the initial information request and/or the subsequent information request. By way of example, the encrypted data publication request 504 may be stored in association with the request log that tracks the interaction through and/or adjacent to the public decentralized environment 406.

In this manner, the intermediary computing entity 402 supports iterative information requests 602 to incrementally supplement data publications 506 with requested information, without exposing the information to the public decentralized environment 406. The information requests 602, for example, may be executed between the participating computing entity 410aand/or the intermediary computing entity 402 until a data publication 506, as described herein, to incrementally provide more visibility into a data publication 506 based on the individual requirements of the participating computing entity 410a.

In some embodiments, after each iteration of an information request 602, the intermediary computing entity 402 encrypts the data publication request to regenerate the encrypted data publication request 504 and stores the encrypted data publication request 504 within the private environment 414.

In some embodiments, the intermediary computing entity 402 receives, from the participating computing entity 410a, a publication response 608. In some examples, the publication response 608 may identify at least one of an alternative correction for the condition and/or a value corresponding to the alternative correction. In addition, or alternatively, the publication response 608 may comprise the assigned correction and/or a value for the assigned correction.

In some embodiments, the publication response 608 comprises a communication between a participating computing entity 410a and an intermediary computing entity 402 that provides a correction for addressing a condition within a data publication 506. In any domain, the publication response 608 may be implemented as an API call between the participating computing entity 410a and the intermediary computing entity 402 that transmits structured data containing the correction details, value, explanation, and/or contextual attributes. The data may be formatted as JSON, XML, and/or the like to ensure consistent parsing and processing by the intermediary computing entity 402.

A publication response 608 may comprise an assigned correction or an alternative correction, a value for the correction, an explanation for the correction, and/or one or more contextual attributes, such as a location of the participating computing entity 410a, and/or the like. For example, in a clinical context, the publication response 608 may comprise a tender for fulfilling a prescription with the type of prescription, an alternative prescription (e.g., that may be approved by the original prescriber), a price for the prescription, a reason for either changing the prescription or choosing the offered price, and/or the like.

More particularly, using a clinical tender system as an example, a publication response 608 may comprise one or more different types of responses. A first type of response may comprise a competing response that competes with the assigned correction. Such responses may comprise a best value (e.g., intrinsic value or price) from up to each of a set of pharmacies, a coupon for the assigned correction from a pharmaceutical manufacturer, a coupon and/or price bundle from a pharmaceutical wholesaler, and/or the like. In such cases, each publication response 608 may offer the same correction at competing values. A second type of response may comprise an alternative response that competes with the assigned correction by offering an alternative correction. Such response may comprise a different generic to the previous prescribed drug, an A2 drug combination comprising a prescription drug and an over the counter remedy to alleviate the side effects reported, another drug and a recommendation for various adjunct therapies, and/or the like. In such cases, each publication response 608 may offer an alternative correction at competing values.

In any domain, the publication response 608 enables a competitive bidding process based on protected attributes, while maintaining security of the protected attributes. This, in turn, allows participants to securely communicate pricing, alternative corrections (e.g., medications, proposals), and explanations (e.g., clinical rationale, value propositions) without exposing sensitive details underlying a publication response 608. In addition, or alternatively, the publication response 608 may allow for corrections beyond a requested, assigned correction (e.g., prescriptions), such as alternative corrections (e.g., medical procedures, diagnostic tests.

In some embodiments, an alternative correction is a correction that modifies an originally assigned correction in any manner (e.g., other than value). An alternative correction, for example, provides an alternative solution to the requested solution for a particular condition. For example, in a clinical context, the alternative correction may comprise a therapy plan to replace a medication prescription. An alternative correction may be used within the public decentralized environment 406 to allow participants to propose different solutions than what was originally prescribed. This enables a more dynamic and cost-effective approach to treatment, leveraging the expertise of multiple participants (e.g., healthcare providers, pharmaceutical entities) to improve outcomes and correction options. In this way, the alternative corrections expand the options available to target entities. In the clinical context, they allow for consideration of newer treatments, different drug formulations, or non-pharmaceutical interventions that may be more effective or have fewer side effects than the original prescription. Thus, the public decentralized environment's 406 ability to present multiple different alternative corrections to a request allows for more informed decision-making with respect to the request in any domain.

In some embodiments, the value of a publication response 608 comprises a requested return for the correction offered by a publication response 608. By way of example, the value may comprise a monetary value, a time expense, and/or the like of an assigned correction and/or alternative correction of the publication response 608.

In some embodiments, the explanation for the correction identifies one or more objective characteristics of the assigned correction and/or alternative correction that may support a target entity's decision on whether to accept or reject the publication response 608. For example, the explanation may comprise one or more quantitative and/or qualitative measures associated with a correction of the publication response 608. In addition, or alternatively, the explanation may describe an adherence (and/or degree thereof) with one or more of the set of correction criteria from the data publication request. In a clinical context for example, the value may represent a composite score of treatment efficacy, side effect profile, patient satisfaction, and/or the like for the assigned correction and/or alternative correction.

In some embodiments, the publication response 608 is received as an encrypted publication response 606. The intermediary computing entity 402 may provide the publication response 608 to the requesting computing entity 404 by decrypting the encrypted publication response 606 to receive the publication response 608. By way of example, to secure any potentially (e.g., directly or inferentially) protected attributes that may be comprised within the publication response 608, the participating computing entity 410a may encrypt the publication response 608 before transmission over a network. The encryption, for example, may be performed using the cryptographic techniques 502, such as asymmetric key encryption, of the present disclosure, and/or any other cryptographic technique controlled by the intermediary computing entity 402.

In some embodiments, the intermediary computing entity 402 provides the publication response 608 (e.g., in an encrypted and/or unencrypted format) to the requesting computing entity 404.

In some embodiments, the intermediary computing entity 402 receives from the requesting computing entity 404, a response acceptance 610 that locks the value of the publication response 608 (e.g., locks the value corresponding to the alternative correction and/or the assigned correction). In some examples, the intermediary computing entity 402 may modify an interactivity of the interactive element within the data publication 506. In addition, or alternatively, the intermediary computing entity 402 may modify the data publication 506 to identify at least one of the value, the correction, and/or the participating computing entity 410a associated with the publication response 608.

In some embodiments, the response acceptance refers to an API call between a requesting computing entity 404 and the intermediary computing entity 402 that identifies one or more of a set of publication responses 608 received from one or more of the set of participating computing entities associated with the public decentralized environment 406. By way of example, the response acceptance 610 may signal one or more accepted tenders offered by one or more different participating computing entities. In this respect, the intermediary computing entity 402 may enable response bundling, in which multiple, complementary publication responses 608 may be accepted at once (e.g., a coupon for a correction from a first publication response 608 and a value for the correction from a second publication response 608).

The response acceptance 610 may be implemented as a structured API request of the requesting API. The request payload may comprise an identifier for the one or more chosen publication responses 608 and/or one or more contextual parameters required to finalize the selection. In some examples, the response acceptance 610 may trigger a data transaction that updates the request log. In addition, or alternatively, the response acceptance 610 may trigger a modification of the status of the chosen publication response 608, mark other responses as rejected, modify and/or remove the data publication 506, and/or the like.

In some embodiments, the computing system 101 removes the data publication 506 from the public decentralized environment 406, stores the value in association with the encrypted data publication request 504, and/or provides an indication of the response acceptance 610 to the participating computing entity 410a associated with the selected publication response 608.

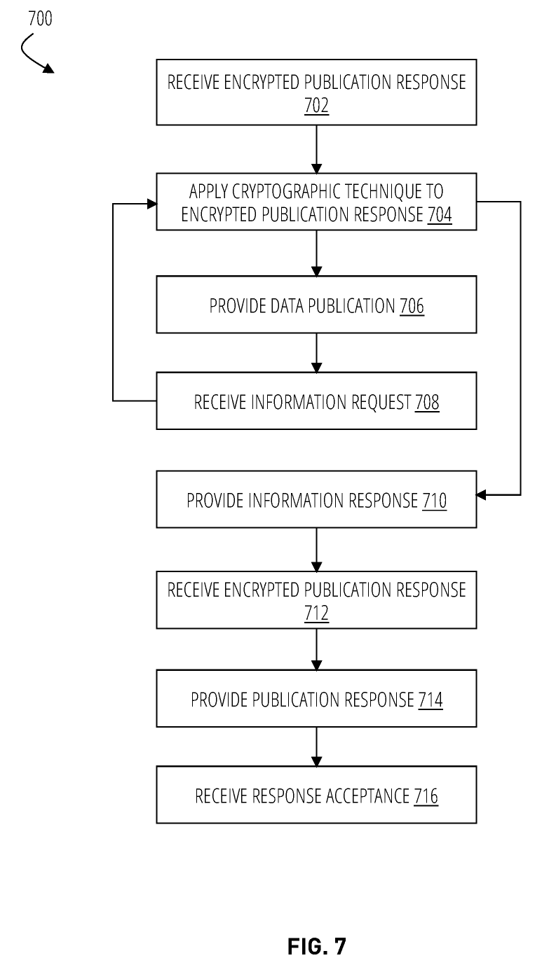

FIG. 7 depicts a flowchart diagram of an encrypted exchange process 700 in accordance with some embodiments of the present disclosure. The flowchart diagram depicts an incremental information sharing process for facilitating public exchange while maintaining security measures over protected information underlying the exchanges. The process 700 may be implemented by one or more computing devices, entities, and/or systems described herein. For example, via the various steps/operations of the process 700, the computing system 101 may incrementally and selectively share information across both a public decentralized environment and associated secure communication channels. By doing so, the process 700 improves computer functionality by integrating greater security infrastructures within a traditionally unsecure, with respect to protected data attributes, public decentralized environment.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving an encrypted publication response. For example, the computing system 101 may receive, from a requesting computing entity, an encrypted data publication request. In some examples, the requesting computing entity may be previously registered with the computing system 101. The encrypted data publication request may be encrypted using a cryptographic technique shared between the requesting computing entity and the intermediary computing entity. In some examples, the cryptographic technique comprises an asymmetric key encryption technique and the encrypted data publication request may be encrypted using a public key shared by the intermediary computer entity and decrypted using a private key corresponding to the public key.

In some embodiments, the process 700 comprises, at operation 704, applying a cryptographic technique to the encrypted publication response. For example, the computing system 101 may decrypt the encrypted data publication request to receive a data publication request that identifies (a) a target entity, (b) a set of entity attributes, (c) a condition, and/or (d) an assigned correction for the condition.

In some embodiments, the process 700 comprises, at operation 706, providing a data publication. For example, the computing system 101 may generate data publication based on a first portion of the data publication request and store the data publication within a public decentralized environment accessible to a set of participating computing entities. The first portion of the data publication request, for example, may comprise the condition and the assigned correction of the data publication request.

The computing system 101 may encrypt the data publication request to regenerate the encrypted data publication request and store the encrypted data publication request within a private environment with an association to the data publication. By way of example, the computing system 101 may assign a publication identifier to the data publication and store the encrypted data publication request in association with the publication identifier.

In some examples, the publication identifier is accessible to the set of participating computing entities. In some examples, the data publication comprises an interactive element configured to initiate an information request, or a publication response associated with the publication identifier.

In some embodiments, the process 700 comprises, at operation 708, receiving an information request. For example, the computing system 101 may receive from a participating computing entity of the set of participating computing entities, an information request that identifies the data publication. In some examples, the computing system 101 may modify a request log corresponding to the data publication in response to the initial information request.

In some embodiments, the process 700 comprises, at operation 710, providing an information response. For example, the computing system 101 may, in response to the request, decrypt, at operation 704, the encrypted data publication request to receive the data publication request. For example, the information request may comprise the publication identifier of the data publication. In some examples, computing system 101 may identify the encrypted data publication request based on the publication identifier and apply the cryptographic technique to the encrypted data publication request. The computing system 101 may generate the information response based on a second portion of the data publication request and provide the information response to the participating computing entity. In some examples, the second portion may comprise a first subset of the set of entity attributes. By way of example, the initial information request may comprise an initial requested attribute, and the first subset of the set of entity attributes may be determined based on the initial requested attribute.

In some examples, the computing system 101 may encrypt the data publication request to regenerate the encrypted data publication request and store the encrypted data publication request within the private environment.

In some embodiments, the computing system 101 receives, from the participating computing entity, a subsequent information request that identifies the data publication and comprises a subsequent requested attribute different than the initial requested attribute. In response to the subsequent information request, the computing system 101 may decrypt the encrypted data publication request to receive the data publication request. The computing system 101 may generate, based on the subsequent requested attribute, a subsequent information response based on a third portion of the data publication request that comprises a second subset of the set of entity attributes. The computing system 101 may provide the subsequent information request to the participating computing entity, encrypt the data publication request to regenerate the encrypted data publication request, and store the encrypted data publication request within the private environment with an indication of the initial information request and the subsequent information request. This process may continue for any number of information requests to incrementally provide supplemental data for a data publication across one or more participating computing entities affiliated with a public decentralized environment.

In some embodiments, the process 700 comprises, at operation 712, receiving an encrypted publication response. For example, the computing system 101 may receive, from the participating computing entity, the publication response. In some examples, the publication response may identify at least one of an alternative correction for the condition and/or a value corresponding to the alternative correction. In addition, or alternatively, the publication response may comprise the assigned correction and/or a value for the assigned correction.

In some embodiments, the process 700 comprises, at operation 714, providing a publication response. For example, the computing system 101 may provide the publication response to the requesting computing entity. In some examples, the publication response is received as an encrypted publication response. The computing system 101 may provide the publication response to the requesting computing entity by decrypting the encrypted publication response to receive the publication response.

In some embodiments, the process 700 comprises, at operation 716, receiving a response acceptance. For example, the computing system 101 may receive, from the requesting computing entity, a response acceptance that locks the value of the publication response (e.g., locks the value corresponding to the alternative correction and/or the assigned correction). In some examples, the intermediary computing entity may modify an interactivity of the interactive element within the data publication. In addition, or alternatively, the intermediary computing entity may modify the data publication to identify at least one of the value, the correction, and/or the participating computing entity associated with the publication response.

In some embodiments, the computing system 101 removes the data publication request from the public decentralized environment, stores the value in association with the data publication request, and/or provides an indication of the response acceptance to the participating computing entity.

Some techniques of the present disclosure enable the generation of action outputs that may be performed to initiate one or more real world actions to achieve real-world effects. The techniques of the present disclosure may be used, applied, and/or otherwise leveraged to execute secure exchanges over a distributed platform and between real world devices. In some examples, the execute exchanges of the present disclosure may trigger action outputs (e.g., through control instructions) to automate robotic actions, and/or the like. The action outputs, for example, may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “comprising,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors and from a requesting computing entity, an encrypted data publication request; decrypting, by the one or more processors, the encrypted data publication request to receive a data publication request that identifies (a) a target entity, (b) a set of entity attributes comprising one or more entity attributes, (c) a condition, and (d) an assigned correction for the condition; generating, by the one or more processors, a data publication based on a first portion of the data publication request; encrypting, by the one or more processors, the data publication request to regenerate the encrypted data publication request; storing, by the one or more processors, the data publication within a public decentralized environment accessible to a set of participating computing entities comprising one or more participating entities; storing, by the one or more processors, the encrypted data publication request within a private environment with an association to the data publication; receiving, by the one or more processors and from a participating computing entity of the set of participating computing entities, an initial information request referencing the data publication; in response to the initial information request, decrypting, by the one or more processors, the encrypted data publication request to receive the data publication request; generating, by the one or more processors, an information response based on a second portion of the data publication request; providing, by the one or more processors, the information response to the participating computing entity; encrypting, by the one or more processors, the data publication request to regenerate the encrypted data publication request; and storing, by the one or more processors, the encrypted data publication request within the private environment; receiving, by the one or more processors and from the participating computing entity, a publication response that identifies an alternative correction for the condition and a value corresponding to the alternative correction; providing, by the one or more processors, the publication response to the requesting computing entity; and receiving, by the one or more processors and from the requesting computing entity, a response acceptance that locks the value corresponding to the alternative correction.

Example 2. The computer-implemented method of claim 1, wherein the requesting computing entity is previously registered with an intermediary computing entity associated with the public decentralized environment and the encrypted data publication request is encrypted using a cryptographic technique shared between the requesting computing entity and the intermediary computing entity.

Example 3. The computer-implemented method of claim 2, wherein the cryptographic technique comprises an asymmetric key encryption technique and the encrypted data publication request is encrypted using a public key shared by the intermediary computing entity and decrypted using a private key corresponding to the public key.

Example 4. The computer-implemented method of claim 1, wherein storing the encrypted data publication request in association with the data publication comprises assigning a publication identifier to the data publication, wherein the publication identifier is accessible to the set of participating computing entities; and storing the encrypted data publication request in association with the publication identifier.

Example 5. The computer-implemented method of claim 4, wherein the initial information request comprises the publication identifier, and the encrypted data publication request is decrypted by identifying the encrypted data publication request based on the publication identifier and applying a cryptographic technique to the encrypted data publication request.

Example 6. The computer-implemented method of claim 1, wherein the data publication comprises an interactive element configured to initiate the initial information request or the publication response, and locking the value corresponding to the alternative correction comprises modifying an interactivity of the interactive element; and modifying the data publication to identify at least one of the value, the alternative correction, or the participating computing entity.

Example 7. The computer-implemented method of claim 1, wherein locking the value corresponding to the alternative correction comprises removing the data publication request from the public decentralized environment; storing the value in association with the data publication request; and providing an indication of the response acceptance to the participating computing entity.

Example 8. The computer-implemented method of claim 1, wherein the first portion of the data publication request comprises the condition and the assigned correction, and the second portion comprises a first subset of the set of entity attributes.

Example 9. The computer-implemented method of claim 8, wherein the initial information request comprises an initial requested attribute, and the first subset of the set of entity attributes is determined based on the initial requested attribute.

Example 10. The computer-implemented method of claim 9, further comprising receiving, from the participating computing entity, a subsequent information request that identifies the data publication and comprises a subsequent requested attribute that is different than the initial requested attribute; and in response to the subsequent information request, decrypting the encrypted data publication request to receive the data publication request, generating, based on the subsequent requested attribute, a subsequent information response based on a third portion of the data publication request that comprises a second subset of the set of entity attributes, providing the subsequent information request to the participating computing entity, encrypting the data publication request to regenerate the encrypted data publication request, and storing the encrypted data publication request within the private environment with an indication of the initial information request and the subsequent information request.

Example 11. The computer-implemented method of claim 1, further comprising modifying a request log corresponding to the data publication in response to the initial information request.

Example 12. The computer-implemented method of claim 1, wherein the publication response is received as an encrypted publication response and providing the publication response to the requesting computing entity comprises decrypting the encrypted publication response to receive the publication response.

Example 13. The computer-implemented method of claim 1, wherein the decryption is performed by an intermediary computing entity that is distinct from the requesting computing entity and the participating computing entity.

Example 14. A system comprising one or more processors; and one or more memories storing processor-executable instructions that, when executed by the one or more processors, cause the one or more processors to perform operations comprising receiving, from a requesting computing entity, an encrypted data publication request; decrypting the encrypted data publication request to receive a data publication request that identifies (a) a target entity, (b) a set of entity attributes comprising one or more entity attributes, (c) a condition, and (d) an assigned correction for the condition; generating a data publication based on a first portion of the data publication request; encrypting the data publication request to regenerate the encrypted data publication request; storing the data publication within a public decentralized environment accessible to a set of participating computing entities comprising one or more participating computing entities; storing the encrypted data publication request within a private environment with an association to the data publication; receiving, from a participating computing entity of the set of participating computing entities, an initial information request referencing the data publication; in response to the initial information request; decrypting the encrypted data publication request to receive the data publication request; generating an information response based on a second portion of the data publication request; providing the information response to the participating computing entity; encrypting the data publication request to regenerate the encrypted data publication request, and storing the encrypted data publication request within the private environment; receiving, from the participating computing entity, a publication response that identifies an alternative correction for the condition and a value corresponding to the alternative correction; providing the publication response to the requesting computing entity; and receiving, from the requesting computing entity, a response acceptance that locks the value corresponding to the alternative correction.

Example 15. The system of claim 14, wherein the requesting computing entity is previously registered with an intermediary computing entity associated with the public decentralized environment and the encrypted data publication request is encrypted using a cryptographic technique shared between the requesting computing entity and the intermediary computing entity.

Example 16. The system of claim 15, wherein the cryptographic technique comprises an asymmetric key encryption technique and the encrypted data publication request is encrypted using a public key shared by the intermediary computing entity and decrypted using a private key corresponding to the public key.

Example 17. The system of claim 14, wherein storing the encrypted data publication request in association with the data publication comprises assigning a publication identifier to the data publication, wherein the publication identifier is accessible to the set of participating computing entities; and storing the encrypted data publication request in association with the publication identifier.

Example 18. The system of claim 17, wherein the initial information request comprises the publication identifier, and the encrypted data publication request is decrypted by identifying the encrypted data publication request based on the publication identifier and applying a cryptographic technique to the encrypted data publication request.

Example 19. One or more non-transitory computer-readable media storing processor-executable instructions that, when executed by one or more processors, cause the one or more processors to perform operations comprising receiving, from a requesting computing entity, an encrypted data publication request; decrypting the encrypted data publication request to receive a data publication request that identifies (a) a target entity, (b) a set of entity attributes comprising one or more entity attributes, (c) a condition, and (d) an assigned correction for the condition; generating a data publication based on a first portion of the data publication request; encrypting the data publication request to regenerate the encrypted data publication request; storing the data publication within a public decentralized environment accessible to a set of participating computing entities comprising one or more participating entities; storing the encrypted data publication request within a private environment with an association to the data publication; receiving, from a participating computing entity of the set of participating computing entities, an initial information request referencing the data publication; in response to the initial information request, decrypting the encrypted data publication request to receive the data publication request; generating an information response based on a second portion of the data publication request; providing the information response to the participating computing entity; encrypting the data publication request to regenerate the encrypted data publication request, and storing the encrypted data publication request within the private environment; receiving, from the participating computing entity, a publication response that identifies an alternative correction for the condition and a value corresponding to the alternative correction; providing the publication response to the requesting computing entity; and receiving, from the requesting computing entity, a response acceptance that locks the value corresponding to the alternative correction.

Example 20. The one or more non-transitory computer-readable media of claim 19, wherein the operations further comprise modifying a request log corresponding to the data publication in response to the initial information request.

What is claimed is:

1. A computer-implemented method comprising:
receiving, by one or more processors and from a requesting computing entity, an encrypted data publication request;
decrypting, by the one or more processors, the encrypted data publication request to receive a data publication request that identifies (a) a target entity, (b) a set of entity attributes comprising one or more entity attributes, (c) a condition, and (d) an assigned correction for the condition;
generating, by the one or more processors, a data publication based on a first portion of the data publication request;
encrypting, by the one or more processors, the data publication request to regenerate the encrypted data publication request;
storing, by the one or more processors, the data publication within a public decentralized environment accessible to a set of participating computing entities comprising one or more participating entities;
storing, by the one or more processors, the encrypted data publication request within a private environment with an association to the data publication;
receiving, by the one or more processors and from a participating computing entity of the set of participating computing entities, an initial information request referencing the data publication;
in response to the initial information request,
decrypting, by the one or more processors, the encrypted data publication request to receive the data publication request;
generating, by the one or more processors, an information response based on a second portion of the data publication request;
providing, by the one or more processors, the information response to the participating computing entity;
encrypting, by the one or more processors, the data publication request to regenerate the encrypted data publication request; and
storing, by the one or more processors, the encrypted data publication request within the private environment;
receiving, by the one or more processors and from the participating computing entity, a publication response that identifies an alternative correction for the condition and a value corresponding to the alternative correction;
providing, by the one or more processors, the publication response to the requesting computing entity; and
receiving, by the one or more processors and from the requesting computing entity, a response acceptance that locks the value corresponding to the alternative correction.

2. The computer-implemented method of claim 1, wherein the requesting computing entity is previously registered with an intermediary computing entity associated with the public decentralized environment and the encrypted data publication request is encrypted using a cryptographic technique shared between the requesting computing entity and the intermediary computing entity.

3. The computer-implemented method of claim 2, wherein the cryptographic technique comprises an asymmetric key encryption technique and the encrypted data publication request is encrypted using a public key shared by the intermediary computing entity and decrypted using a private key corresponding to the public key.

4. The computer-implemented method of claim 1, wherein storing the encrypted data publication request in association with the data publication comprises:
assigning a publication identifier to the data publication, wherein the publication identifier is accessible to the set of participating computing entities; and
storing the encrypted data publication request in association with the publication identifier.

5. The computer-implemented method of claim 4, wherein the initial information request comprises the publication identifier, and the encrypted data publication request is decrypted by identifying the encrypted data publication request based on the publication identifier and applying a cryptographic technique to the encrypted data publication request.

6. The computer-implemented method of claim 1, wherein the data publication comprises an interactive element configured to initiate the initial information request or the publication response, and locking the value corresponding to the alternative correction comprises:
modifying an interactivity of the interactive element; and
modifying the data publication to identify at least one of the value, the alternative correction, or the participating computing entity.

7. The computer-implemented method of claim 1, wherein locking the value corresponding to the alternative correction comprises:
removing the data publication request from the public decentralized environment;
storing the value in association with the data publication request; and
providing an indication of the response acceptance to the participating computing entity.

8. The computer-implemented method of claim 1, wherein the first portion of the data publication request comprises the condition and the assigned correction, and the second portion comprises a first subset of the set of entity attributes.

9. The computer-implemented method of claim 8, wherein the initial information request comprises an initial requested attribute, and the first subset of the set of entity attributes is determined based on the initial requested attribute.

10. The computer-implemented method of claim 9, further comprising:
receiving, from the participating computing entity, a subsequent information request that identifies the data publication and comprises a subsequent requested attribute that is different than the initial requested attribute; and
in response to the subsequent information request,
decrypting the encrypted data publication request to receive the data publication request,
generating, based on the subsequent requested attribute, a subsequent information response based on a third portion of the data publication request that comprises a second subset of the set of entity attributes,
providing the subsequent information request to the participating computing entity,
encrypting the data publication request to regenerate the encrypted data publication request, and
storing the encrypted data publication request within the private environment with an indication of the initial information request and the subsequent information request.

11. The computer-implemented method of claim 1, further comprising modifying a request log corresponding to the data publication in response to the initial information request.

12. The computer-implemented method of claim 1, wherein the publication response is received as an encrypted publication response and providing the publication response to the requesting computing entity comprises decrypting the encrypted publication response to receive the publication response.

13. The computer-implemented method of claim 1, wherein the decryption is performed by an intermediary computing entity that is distinct from the requesting computing entity and the participating computing entity.

14. A system comprising:
one or more processors; and
one or more memories storing processor-executable instructions that, when executed by the one or more processors, cause the one or more processors to perform operations comprising:
receiving, from a requesting computing entity, an encrypted data publication request;
decrypting the encrypted data publication request to receive a data publication request that identifies (a) a target entity, (b) a set of entity attributes comprising one or more entity attributes, (c) a condition, and (d) an assigned correction for the condition;
generating a data publication based on a first portion of the data publication request;
encrypting the data publication request to regenerate the encrypted data publication request;
storing the data publication within a public decentralized environment accessible to a set of participating computing entities comprising one or more participating computing entities;
storing the encrypted data publication request within a private environment with an association to the data publication;
receiving, from a participating computing entity of the set of participating computing entities, an initial information request referencing the data publication;
in response to the initial information request,
decrypting the encrypted data publication request to receive the data publication request;
generating an information response based on a second portion of the data publication request;
providing the information response to the participating computing entity;
encrypting the data publication request to regenerate the encrypted data publication request; and
storing the encrypted data publication request within the private environment;
receiving, from the participating computing entity, a publication response that identifies an alternative correction for the condition and a value corresponding to the alternative correction;
providing the publication response to the requesting computing entity; and
receiving, from the requesting computing entity, a response acceptance that locks the value corresponding to the alternative correction.

15. The system of claim 14, wherein the requesting computing entity is previously registered with an intermediary computing entity associated with the public decentralized environment and the encrypted data publication request is encrypted using a cryptographic technique shared between the requesting computing entity and the intermediary computing entity.

16. The system of claim 15, wherein the cryptographic technique comprises an asymmetric key encryption technique and the encrypted data publication request is encrypted using a public key shared by the intermediary computing entity and decrypted using a private key corresponding to the public key.

17. The system of claim 14, wherein storing the encrypted data publication request in association with the data publication comprises:
assigning a publication identifier to the data publication, wherein the publication identifier is accessible to the set of participating computing entities; and
storing the encrypted data publication request in association with the publication identifier.

18. The system of claim 17, wherein the initial information request comprises the publication identifier, and the encrypted data publication request is decrypted by identifying the encrypted data publication request based on the publication identifier and applying a cryptographic technique to the encrypted data publication request.

19. One or more non-transitory computer-readable media storing processor-executable instructions that, when executed by one or more processors, cause the one or more processors to perform operations comprising:
receiving, from a requesting computing entity, an encrypted data publication request;
decrypting the encrypted data publication request to receive a data publication request that identifies (a) a target entity, (b) a set of entity attributes comprising one or more entity attributes, (c) a condition, and (d) an assigned correction for the condition;
generating a data publication based on a first portion of the data publication request;
encrypting the data publication request to regenerate the encrypted data publication request;
storing the data publication within a public decentralized environment accessible to a set of participating computing entities comprising one or more participating entities;
storing the encrypted data publication request within a private environment with an association to the data publication;
receiving, from a participating computing entity of the set of participating computing entities, an initial information request referencing the data publication;
in response to the initial information request,
decrypting the encrypted data publication request to receive the data publication request;
generating an information response based on a second portion of the data publication request;
providing the information response to the participating computing entity;
encrypting the data publication request to regenerate the encrypted data publication request; and
storing the encrypted data publication request within the private environment;
receiving, from the participating computing entity, a publication response that identifies an alternative correction for the condition and a value corresponding to the alternative correction;
providing the publication response to the requesting computing entity; and
receiving, from the requesting computing entity, a response acceptance that locks the value corresponding to the alternative correction.

20. The one or more non-transitory computer-readable media of claim 19, wherein the operations further comprise modifying a request log corresponding to the data publication in response to the initial information request.
